(19) United States
(12) Patent Application Publication
(10) Pub. No.: US 2003/0014348 A1
(43) Pub. Date: Jan. 16, 2003

(54) Apparatus and method for providing pricing hints during an on-line auction

(75) Inventors: Thomas J. O'Connor, Round Rock, TX (US); Jacob Marvin Rzepka, Round Rock, TX (US); Donna Ann Unruh, Leander, TX (US); William K. Wittenbrook, Austin, TX (US)

Correspondence Address: Rudolf O. Siegesmund, Suite 2000, 4627 N. Central Expressway, Dallas, TX, 75205-4022, US

(73) Assignee: International Business Machines Corporation, Armonk, NY (US)

(21) Appl. No.: 09/903,724

(22) Filed: Jul. 12, 2001

(51) Int. Cl. G06F 17/60

(52) U.S. Cl. 705/37

(57) ABSTRACT

An apparatus and method for providing assistance to a participant in an on-line auction is disclosed. The assistance is based upon selection of a bid advisor program. The bid advisor program offers a choice of three different types of pricing data derived from three different data bases—an historical data base, a current price offering data base, a market value data base. Once the participant selects the type of pricing hint desired, an algorithm searches the appropriate data base for the closest match on pricing and displays the suggested price. When the participant selects a price, the bid is placed and the bid assistant program either goes to another bid or is closed.

### FIELD OF THE INVENTION

The present invention relates to an apparatus and method for providing pricing hints to a consumer participating in an auction conducted over the Internet.

### BACKGROUND OF THE INVENTION

E-commerce on the Internet expands along with the number of households that have computers. Many consumers shop from home over the Internet by way of auctions. Some vendors provide a price ceiling which over estimates product value. Pricing search engines exist for retail sites, but not for auction sites. Current auction sites do not provide the consumer with an online capability to evaluate current market value of the items for sale on the auction site. In many cases, items being auctioned have a retail value, or a computable market value that could be made available to the consumer. By identifying the competitive cost of the product, the auction participant will be allowed to make a better decision in making a bid to purchase the product, thereby increasing the chances for winning the bid. In addition, the auction web site owner receives a percentage of the final price paid. Therefore, the closer the auction participant bid is to the market value, the higher the profit potential for the auction host.

What is needed beyond the prior art is a way to provide a pricing “hint” based on a dynamic market value, an historical pricing of the same item, or an established price for which the product is currently selling.

### SUMMARY OF THE INVENTION

The invention which meets the needs identified above is an apparatus and method for providing assistance to a participant in an on-line auction that allows selection of a bid advisor program. The bid advisor program offers a choice of three different types of pricing data derived from three different data bases—an historical data base, a current price offering data base, a market value data base. Once the participant selects the type of pricing hint desired, an algorithm searches the appropriate data base for the closest match on pricing and displays the suggested price. When the participant selects a price, the bid is placed and the bid assistant program either goes to another bid or is closed.

### BRIEF DESCRIPTION OF THE DRAWINGS

The novel features believed characteristic of the invention are set forth in the appended claims. The invention itself, however, as well as a preferred mode of use, further objectives and advantages thereof, will best be understood by reference to the following detailed description of an illustrative embodiment when read in conjunction with the accompanying drawings, wherein:

FIG. 1 is depiction of a distributed data processing system;

FIG. 2 is a depiction of a server computer;

FIG. 3 is a depiction of a client computer;

FIG. 4 is a depiction of the server memory; and

FIG. 5 is a flow chart of the bid assistant program.

### DETAILED DESCRIPTION OF THE PREFERRED EMBODIMENT

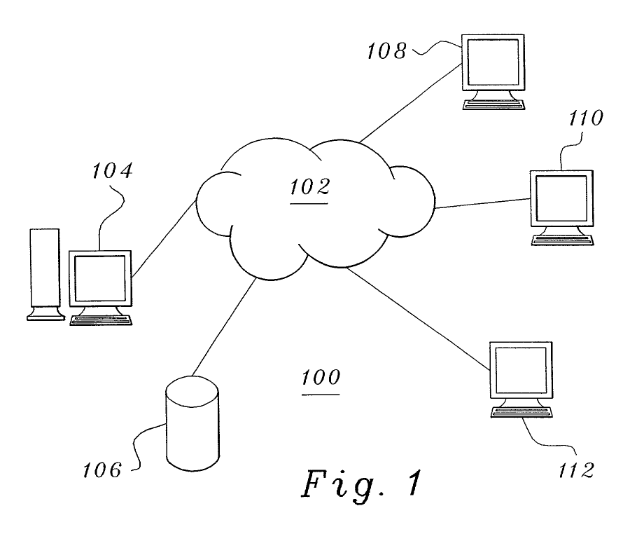

FIG. 1 depicts a pictorial representation of a distributed data processing system in which the present invention may be implemented and is intended as an example, and not as an architectural limitation, for the processes of the present invention. Distributed data processing system 100 is a network of computers which contains network 102, which is the medium used to provide communication links between various devices and computers connected together within distributed data processing system 100. Network 102 may include permanent connections, such as wire or fiber optic cables, or temporary connections made through telephone connections. In the depicted example, server 104 is connected to network 102 along with storage unit 106. In addition, clients 108, 110, and 112 also are connected to a network 102. Clients 108, 110, and 112 may be, for example, personal computers or network computers.

For purposes of this application, a network computer is any computer, coupled to a network, which receives a program or other application from another computer coupled to the network. In the depicted example, server 104 provides Web based applications to clients 108, 110 and 112. Clients 108, 110, and 112 are clients to server 104. Distributed data processing system 100 may include additional servers, clients, and other devices not shown. In the depicted example, distributed data processing system 100 is the Internet with network 102 representing a worldwide collection of networks and gateways that use the TCP/IP suite of protocols to communicate with one another. Distributed data processing system 100 may also be implemented as a number of different types of networks, such as for example, an intranet, a local area network (LAN), or a wide area network (WAN).

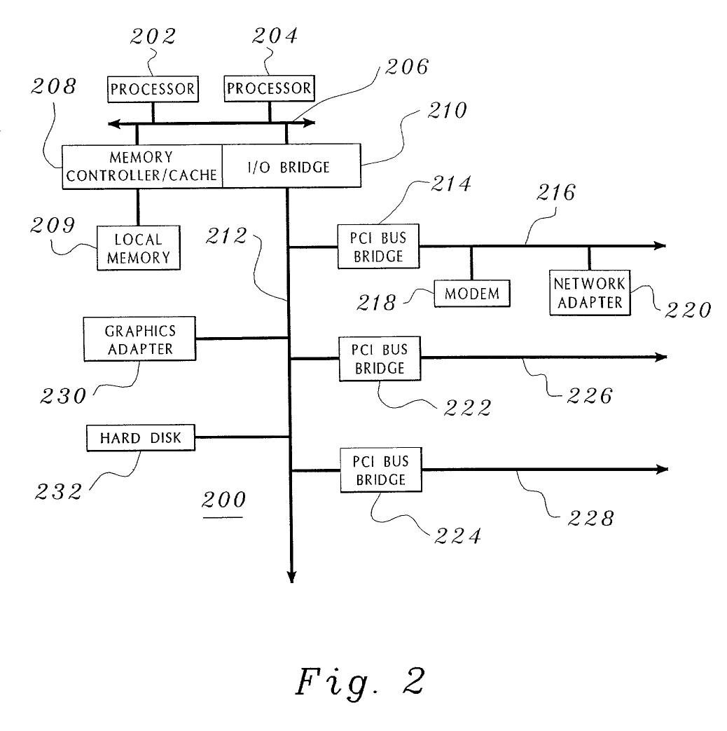

Referring to FIG. 2, a block diagram depicts a data processing system, which may be implemented as a server, such as server 104 in FIG. 1 in accordance with the present invention. Data processing system 200 may be a symmetric multiprocessor (SMP) system including a plurality of processors such as first processor 202 and second processor 204 connected to system bus 206. Alternatively, a single processor system may be employed. Also connected to system bus 206 is memory controller/cache 208, which provides an interface to local memory 209. I/O bus bridge 210 is connected to system bus 206 and provides an interface to I/O bus 212. Memory controller/cache 208 and I/O bus bridge 210 may be integrated as depicted. Peripheral component interconnect (PCI) bus bridge 214 connected to I/O bus 212 provides an interface to first PCI local bus 216. Modem 218 may be connected to first PCI bus local 216. Typical PCI bus implementations will support four PCI expansion slots or add-in connectors. Communication links to network computers 108, 110, and 112 in FIG. 1 may be provided through modem 218 and network adapter 220 connected to first PCI local bus 216 through add-in boards. Additional PCI bus bridges such as second PCI bus bridge 222 and third PCI bus bridge 224 provide interfaces for additional PCI local buses such as second PCI local bus 226 and third PCI local bus 228, from which additional modems or network adapters may be supported. In this manner, server 200 allows connections to multiple network computers. A memory-mapped graphics adapter 230 and hard disk 232 may also be connected to I/O bus 212 as depicted, either directly or indirectly. Those of ordinary skill in the art will appreciate that the hardware depicted in FIG. 2 may vary. For example, other peripheral devices, such as an optical disk drive and the like also may be used in addition or in place of the hardware depicted. The depicted example is not meant to imply architectural limitations with respect to the present invention. The data processing system depicted in FIG. 2 may be, for example, an IBM RISC/System 6000 system, a product of International Business Machines Corporation in Armonk, N.Y., running the Advanced Interactive Executive (AIX) operating system.

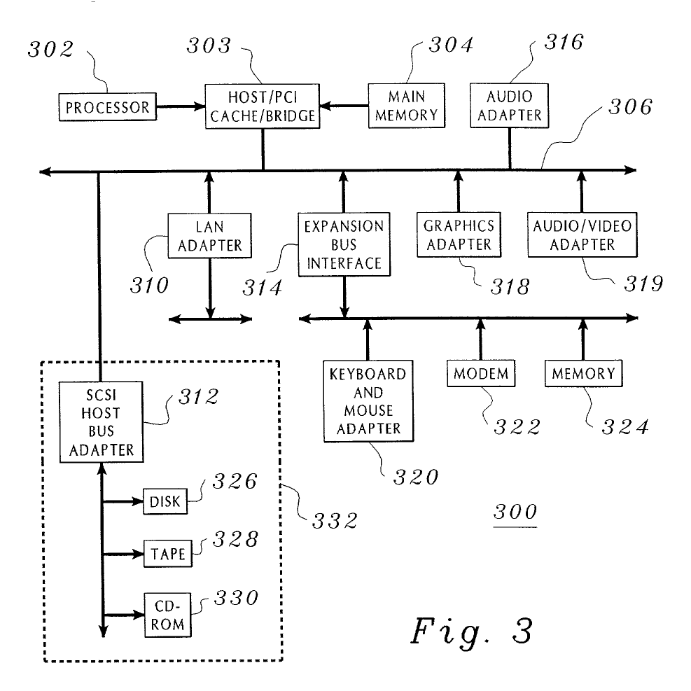

With reference now to FIG. 3, a block diagram illustrates a data processing system in which the invention may be implemented. Data processing system 300 is an example of either a stand-alone computer, if not connected to distributed data processing system 100, or a client computer, if connected to distributed data processing system 100. Data processing system 300 employs a peripheral component interconnect (PCI) local bus architecture. Although the depicted example employs a PCI bus, other bus architectures such as Micro Channel and ISA may be used. Processor 302 and main memory 304 are connected to PCI local bus 306 through PCI bridge 303. PCI bridge 303 also may include an integrated memory controller and cache memory for Processor 302. Additional connections to PCI local bus 306 may be made through direct component interconnection or through add-in boards. In the depicted example, local area network (LAN) adapter 310, SCSI host bus adapter 312, and expansion bus interface 314 are connected to PCI local bus 306 by direct component connection. In contrast, audio adapter 316, graphics adapter 318, and audio/video adapter (A/V) 319 are connected to PCI local bus 306 by add-in boards inserted into expansion slots. Expansion bus interface 314 provides a connection for a keyboard and mouse adapter 320, modem 322, and additional memory 324. SCSI host bus adapter 312 provides a connection for hard disk drive 326, tape drive 328, and CD-ROM 330 in the depicted example. Typical PCI local bus implementations will support three or four PCI expansion slots or add-in connectors. An operating system runs on processor 302 and is used to coordinate and provide control of various components within data processing system 300 in FIG. 3. The operating system may be a commercially available operating system such as OS/2, which is available from International Business Machines Corporation. “OS/2” is a trademark of International Business Machines Corporation. An object oriented programming system, such as Java, may run in conjunction with the operating system and provides calls to the operating system from Java programs or applications executing on data processing system 300. “Java” is a trademark of Sun Microsystems, Incorporated. Instructions for the operating system, the object-oriented operating system, and applications or programs may be located on storage devices, such as hard disk drive 326, and they may be loaded into main memory 304 for execution by processor 302. Those of ordinary skill in the art will appreciate that the hardware in FIG. 3 may vary depending on the implementation. Other internal hardware or peripheral devices, such as flash ROM (or equivalent nonvolatile memory) or optical disk drives and the like, may be used in addition to or in place of the hardware depicted in FIG. 3. Also, the processes of the present invention may be applied to a multiprocessor data processing system. For example, data processing system 300, if configured as a network computer, may not include SCSI host bus adapter 312, hard disk drive 326, tape drive 328, and CD-ROM 330, as noted by the box with the dotted line in FIG. 3 denoting optional inclusion. In that case, the computer, to be properly called a client computer, must include some type of network communication interface, such as LAN adapter 310, modem 322, or the like. As another example, data processing system 300 may be a stand-alone system configured to be bootable without relying on some type of network communication interface, whether or not data processing system 300 comprises some type of network communication interface. As a further example, data processing system 300 may be a Personal Digital Assistant (PDA) device which is configured with ROM and/or flash ROM in order to provide non-volatile memory for storing operating system files and/or user-generated data. The depicted example in FIG. 3 and above-described examples are not meant to imply architectural limitations with respect to the present invention. It is important to note that while the present invention has been described in the context of a fully functioning data processing system, those of ordinary skill in the art will appreciate that the processes of the present invention are capable of being distributed in a form of a computer readable medium of instructions and a variety of forms and that the present invention applies equally regardless of the particular type of signal bearing media actually used to carry out the distribution. Examples of computer readable media include recordable-type media, such a floppy disc, a hard disk drive, a RAM, and CD-ROMs, and transmission-type media, such as digital and analog communications links.

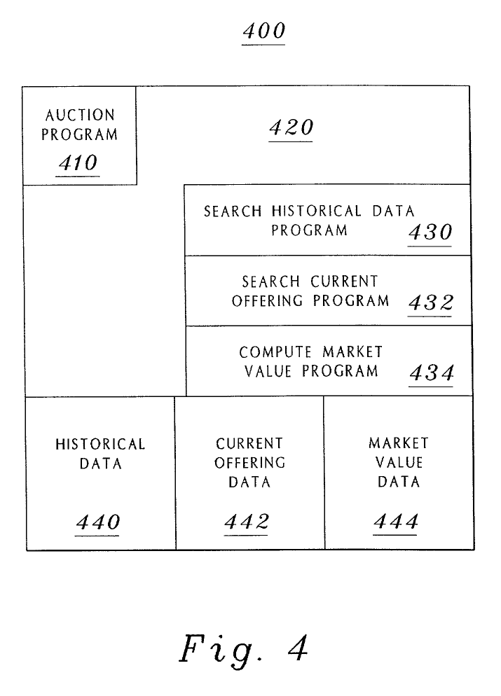

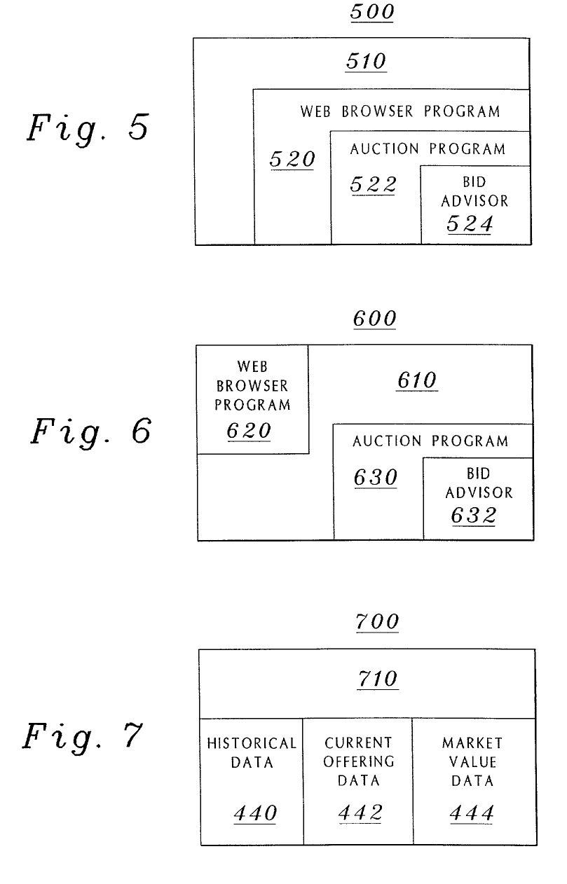

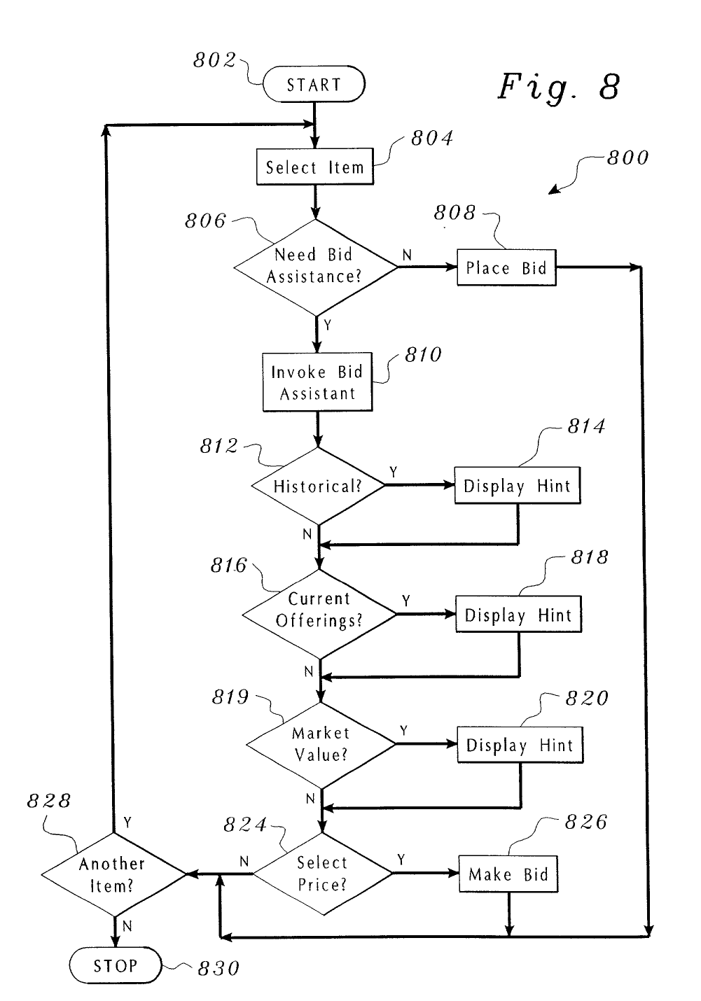

FIG. 4 depicts first memory space 400 containing bid advisor 500 (See FIG. 5). Memory 400 contains first auction program 410, first available memory 420, search historical data program 430, search current offerings program 432, and search market value program 434. Also contained in memory 400 are historical data base 440, current offerings data base 442, and market value data base 444. Search historical data program 430 accesses historical data base 440, identifies a product in historical data base 440 that matches an online sale offering, and causes the price paid for the product to be displayed. Search current offerings program 432 accesses current offerings data base 442, identifies a product matching the on-line sale offering that is currently being publicly offered for sale, such as at a retail store, a web site, or catalog, and causes the current offering price to be displayed. Market value program 434 accesses current market value data base 444, identifies a given number of products that are similar to the on-line sale offering, calculates a market value for the on-line sale offer from the similar products, and causes the calculated value to be displayed. In the preferred embodiment, memory space 400 is located in a server computer such data processing system 200 in FIG. 2.

FIG. 5 depicts second memory space 500 containing second available memory 510, first web browser program 520, second auction program 522, and second bid advisor program 524. In an alternate embodiment, second auction program 522 may be contained in first web browser program 520. As used herein, the term web browser shall mean a software program that (1) accesses and displays Hypertext Markup Language (HTML) documents in a computer connected to the Internet and (2) accesses files and software related to the HTML documents. Second auction program 522 is included in first web browser program 520 as original installation, or as an update or plug-in downloaded from a network such as network 102 (see FIG. 1). Second memory 500 may be located in a computer such as data processing system 300 (see FIG. 3).

FIG. 6 depicts third memory space 600 containing second web browser program 620, third available space 610, third auction program 630, and third bid advisor program 632. In an alternate embodiment, third auction program 630 may be installed in third memory space 600 by downloading from a network such as network 102 (see FIG. 1), or loading from a disk or from a compact disc read-only memory (CD-ROM). Third memory space 600 may be located in a computer such as data processing system 300 (see FIG. 3).

FIG. 7 depicts fourth memory space 700. Fourth memory space has historical data base 440, current offering data base 442 and market value data base 446. In an alternate embodiment, where second auction program 522 or third auction program 630 are located in the memory of a computer such as data processing system 300 (see FIG. 3), the data bases to support second bid advisor program 524 and third bid advisor program 632 may be located alone in one or more server computers such as data processing system 200 in FIG. 2.

FIG. 8, depicts a flow chart for bid advisor 800. In the preferred embodiment, bid advisor 800 is located in the memory of a server computer such as data processing system 200. (see FIG. 2). Alternatively, bid advisor 800 may be built into a web browser program, incorporated into a web browser program as a plug-in, or placed in the memory of a computer along with a web browser program in a computer such as data processing system 300 (see FIG. 3). Bid advisor 800 begins (802). An item is selected by the user (804). Bid advisor 800 determines whether the user wants assistance with his or her bid (806). If the user does not wants assistance, then bid advisor 800 displays a message asking the user to place a bid (808). If the user does want assistance options, then the user invokes bid assistant (810). Bid assistant 810 determines whether the user wants to use historical data (812), current offerings (816), or market value (820) based on the user selection. If the user selects historical data (812), a pricing hint is displayed (814) based on historical data. The pricing hint based on historical data is identified by accessing a historical data base, identifying a price paid at an earlier date for a product matching the online sale offering, and displaying the historical price on the user's computer. The foregoing actions are accomplished by a search historical data program within a bid advisor program in the memory of a server computer, or alternatively in the memory of the auction participant's computer such as search historical data program 430 (see FIG. 4). If the user selects current offerings (816) then a pricing hint is displayed (818) based on current offerings. The pricing hint based on current offerings is identified by accessing a current offerings data base, identifying the price at which the on-line sale offering is currently being publicly offered for sale, and displaying the currently offered price on the user's computer. The foregoing actions are accomplished by a search current offering program within a bid advisor program in the memory of a server computer, or alternatively in the memory of the auction participant's computer such as search current offerings program 432 of FIG. 4. If the user selects market value, then a hint is displayed (820) based on market value. The pricing hint based on market value is identified by accessing a market value data base, identifying a given number of similar products to the on-line sale offering, calculating a market value based on the similar products, and displaying the market value on the user's computer. The foregoing actions are accomplished by a compute market value program within a bid advisor program in the memory of a server computer, or alternatively in the memory of the auction participant's computer such as compute market value program 434 (see FIG. 4). Next a determination is made as to whether the user is ready to select a price (824). If the user is ready to select a price, the user makes a bid (826) based upon that price. If the user is not ready to select a price, bid advisor 800 determines whether the user wants to make a bid on another item. (828). If the user wants to makea bid on another item, the program returns to step 804. If the user does not want to bid on another item, the program ends (830).

The advantages provided by the present invention should be apparent in light of the detailed description provided above. The description of the present invention has been presented for purposes of illustration and description, but is not limited to be exhaustive or limited to the invention in the form disclosed. Many modifications and variations will be apparent to those of ordinary skill in the art. The embodiment was chosen and described in order to best explain the principles of the invention, the practical application, and to enable others of ordinary skill in the art to understand the invention for various embodiments with various modifications as are suited to the particular use contemplated.

What is claimed:

1. A programmable apparatus for providing a pricing hint to a first computer connected to a network comprising:
a second computer connected to the network;
a database in the memory of the second computer;
a program in the memory of the second computer for causing the first computer to display the pricing hint.

2. The programmable apparatus of claim 1 wherein the program determines the pricing hint based on historical data.

3. The programmable apparatus of claim 1 wherein the program determines the pricing hint based on current prices.

4. The programmable apparatus of claim 1 wherein the program provides the pricing hint based on market value.

5. A method for providing a pricing hint during an on-line auction comprising the steps of:
selecting an item on which to bid;
invoking a bid advisor program;
selecting a type of bid assistance; and
determining a pricing hint based on the type of bid assistance selected.

6. The method of claim 5 further comprising the step of placing a bid.

7. The method of claim 5 further comprising the step of selecting a bid assistant.

8. The method of claim 5 further comprising the step of selecting bid assistance based upon historical pricing.

9. The method of claim 5 further comprising the step of selecting bid assistance based upon market value.

10. The method of claim 5 further comprising the step of selecting bid assistance based upon current offering.

11. A programmable apparatus for providing pricing hints during an on-line auction comprising:
programmable hardware comprising:
a server computer;
a client computer;
a database;
a network connecting the server computer, the client computer, and the data base; and
a bid advisor program installed on said server computer;
wherein the bid advisor program causes the client computer to display the pricing hint.

12. The programmable apparatus of claim 11 further comprising an historical pricing program installed on said server computer.

13. The programmable apparatus of claim 11 further comprising a current price pricing program installed on said server computer.

14. The programmable apparatus of claim 11 further comprising a market value pricing program installed on said server computer.

15. The programmable apparatus of claim 11 further comprising an historical pricing data base in said server computer.

16. The programmable apparatus of claim 11 further comprising a current price data base said server computer.

17. The programmable apparatus of claim 11 further comprising a market value data base in said computer.

18. The programmable apparatus of claim 11 wherein said bid advisor program causes the client computer to access an historical price data base.

19. The programmable apparatus of claim 11 wherein said bid advisor program causes the client to access a current price data base.

20. The programmable apparatus of claim 11 wherein said bid advisor program causes the client computer to access a market value data base.

21. A computer readable memory for causing a computer to provide a pricing hint during an on-line auction comprising:
a computer readable storage medium;
a data base accessible to said computer;
a computer program stored in said storage medium;
wherein the storage medium, so configured by said computer program, causes the computer to display the pricing hint.

22. The computer readable memory of claim 21 further comprising a market value pricing program installed in said memory.

23. The computer readable memory of claim 21 further comprising an historical price program installed in said memory.

24. The computer readable memory of claim 21 further comprising a current price program in said memory.

25. The computer readable memory of claim 21 further comprising a market value data base in said memory.

26. The computer readable memory of claim 21 further comprising an historical pricing data base in said memory.

27. The computer readable memory of claim 21 further comprising a current price data base in said memory.

28. The computer readable memory of claim 21 further comprising a market value data base in said memory.

29. A programmable apparatus for providing pricing hints during an on-line auction comprising:
programmable hardware comprising;
a server computer;
a client computer;
a database containing historical data, current offering data, and market value data located in a memory of the server computer;
a web browser program installed on said client computer;
a bid advisor program installed on said client computer; and
a network connecting the server computer, the client computer, and the data base;
wherein the bid advisor program causes the pricing hint to be displayed on said client computer.

30. The programmable apparatus of claim 29 wherein the bid advisor program further comprises an search historical price program.

31. The programmable apparatus of claim 29 wherein the bid advisor program further comprises a search current price program.

32. The programmable apparatus of claim 29 wherein the bid advisor program further comprises a compute market value program.

33. The programmable apparatus of claim 29 wherein the data base further comprises an historical pricing data base.

34. The programmable apparatus of claim 29 wherein the data base further comprises a current price data base.

35. The programmable apparatus of claim 29 wherein the data base further comprises a market value data base.

36. The programmable apparatus of claim 29 wherein the bid advisor program is included within the web browser program.
